(19) United States
(12) Patent Application Publication
(10) Pub. No.: US 2007/0300193 A1
(43) Pub. Date: Dec. 27, 2007

(54) Enhanced Computer-Aided Design and Methods Thereof

(75) Inventors: John Lillis, Oak Park, IL (US); Milos Hrkic, Princeton, NJ (US)

Correspondence Address: AKERMAN SENTERFITT, P.O. BOX 3188, WEST PALM BEACH, FL, 33402-3188, US

(73) Assignee: THE BOARD OF TRUSTEES OF THE UNIVERSITY OF ILLINOI, Urbana, IL (US)

(21) Appl. No.: 11/569,546

(22) PCT Filed: May 24, 2005
(86) PCT No.: PCT/US05/18162

§ 371 Date: Nov. 22, 2006

Related U.S. Application Data
(60) Provisional application No. 60/575,250, filed on May 28, 2004.

(51) Int. Cl. G06F 17/50

(52) U.S. Cl. 716/3

(57) ABSTRACT

A Computer-Aided Design (CAD) system operates according to a method (100) having the steps of placing (102) a plurality of cells of one or more circuits in a layout, generating (106) a plurality of fanin trees from the layout, applying (110) fanin tree embedding on the plurality of fanin trees, and generating (112) a new layout from the embedded fanin trees.

### FIELD OF THE INVENTION

This invention relates generally to integrated route and placement techniques, and more particularly to an enhanced computer-aided design and methods thereof.

### BACKGROUND OF THE INVENTION

The idea of logic replication is to duplicate certain cells in a design so as to enable more effective optimization of one or more design objectives. The idea has been applied in different contexts including min-cut partitioning and fanout tree optimization as described in the following publications incorporated herein by reference:

L. T. Liu, M. T. Kuo, C. K. Cheng, T. C. Hu, “A Replication Cut for Two-Way Partitioning,” IEEE Transactions on CAD, 1995 (referred to herein as “Reference [1]”);

W. K. Mak, D. F. Wong, “Minimum Replication Min-Cut Partitioning,” IEEE Transactions on CAD, October 1997 (referred to herein as “Reference [2]”);

J. Lillis, C. K. Cheng, T. T. Y Lin, “Algorithms for Optimal Introduction of Redundant Logic for Timing and Area Optimization,” Proc. IEEE International Symposium on Circuits and Systems, 1996 (referred to herein as “Reference [3]”); and

A. Srivastava, R. Kastner, M. Sarrafzadeh, “Timing Driven Gate Duplication: Complexity Issues and Algorithms,” ICCAD, 2000 (referred to herein as “Reference [4]”).

Recently the idea of using replication to effectively deal with interconnect-dominated delay at the physical level has been explored by the following publications incorporated herein in by reference:

G. Beraudo, J. Lillis, “Timing Optimization of FPGA Placements by Logic Replication,” DAC, 2003 (referred to herein as “Reference [5]”);

W. Gosti, A. Narayan, R. K. Brayton, A. L. Sangiovanni-Vincentelli, “Wireplanning In logic Synthesis,” ICCAD, 1998 (referred to herein as “Reference [6]”); and

W. Gosti, S. P Khatri, A. L. Sangiovanni-Vincentelli, “Addressing The Timing Closure Problem By Integrating Logic Optimization and Placement,” ICCAD, 2001 (referred to herein as “Reference [7]”).

In these publications it is observed that, because replication effectively separates multiple signal paths it becomes easier, at the physical design level, to “straighten” input-to-output (flip-flop to flip-flop) paths, which might otherwise have been very circuitous (and therefore of high delay).

A simple example from Reference [1] reproduced in FIGS. 1 and 2 illustrates the idea. Suppose that the terminals at a, b, d and e are fixed. There are four distinct input-to-output paths. Any movement of the central cell c from the shown location will degrade the delay of at least one of these paths (assume for the moment a linear delay model). Thus in FIG. 1 there is no choice but to tolerate non-monotone input-to-output paths. Now suppose that cell c is replicated as shown in FIG. 2 to form c′ computing the same function, but feeding only output b while c drives only d. If such a logically equivalent netlist is produced all input-to-output paths become virtually monotone.

Reference [1] made a compelling case for the potential of replication by observing that not only do typical placements contain critical paths which are highly non-monotone, but also that the number of cells which have near-critical paths flowing through them is relatively small. Thus, one may conjecture that a small amount of replication may be sufficient. Then an incremental replication procedure was proposed and evaluated experimentally with promising results. Roughly speaking the algorithm examined the current critical path and looked for cells to replicate. For such cells, it placed the duplicate, performed fanout partitioning and then legalized the placement. The criteria for selecting a cell was based on the goal of inducing local monotonicity.

Local monotonicity was defined by a sequence of 3 cells on a path ν₁, ν₂, ν₃. Letting d(u,ν) be the rectilinear distance between cells u and ν, it follows then that the path from ν₁ to ν₃ is non-monotone if d(ν₁, ν₃)<d(ν₁, ν₂)+d(ν₂, d₃) (i.e., traveling to ν₂ creates a detour). hi such a case, ν₂ is a good candidate for replication so as to straighten this path without disturbing other paths passing through ν₂.

While this strategy proved effective in reducing clock period, it is now observed that a technique based on local monotonicity has limitations. FIG. 3 demonstrates this limitation. In FIG. 3 depicts a critical path (s, a, b, t) (dashed lines indicate other signal paths which may be near critical). Clearly, this path is non-monotone and yet, all sub-paths (of length 3) are locally monotone. In this case (which is not unusual), the approach is unable to improve the delay.

Accordingly, a need arises to improve timing, placement and routing of cells.

### SUMMARY OF THE INVENTION

Embodiments in accordance with the invention provide an enhanced computer-aided design and methods thereof.

In a first embodiment of the present invention, a Computer-Aided Design (CAD) system has a computer-readable storage medium. The storage medium includes computer instructions for placing a plurality of cells of one or more circuits in a layout, generating a plurality of fanin trees from the layout, applying fanin tree embedding on the plurality of fanin trees, and generating a new layout from the embedded fanin trees.

In a second embodiment of the present invention, a Computer-Aided Design (CAD) system operates according to a method having the steps of placing a plurality of cells of one or more circuits in a layout, generating a plurality of fanin trees from the layout, applying fanin tree embedding on the plurality of fanin trees, and generating a new layout from the embedded fanin trees.

In a third embodiment of the present invention, a Computer-Aided Design (CAD) system has a computer-readable storage medium. The storage medium includes computer instructions for placing a plurality of cells of one or more circuits in a layout, generating a static timing analysis from the layout, generating a plurality of fanin trees from the layout based on replication trees and the static timing analysis, applying fanin tree embedding on the plurality of fanin trees, generating a new layout from the embedded fanin trees, and repeating the foregoing steps with the exception of the placing step.

### BRIEF DESCRIPTION OF THE DRAWINGS

FIG. 1 depicts a prior art system with forced non-monotone paths;

FIG. 2 depicts a prior art system illustrating path straightening by cell replication;

FIGS. 4-5 depict fanin tree embedding according to an embodiment of the present invention;

FIGS. 6-7 depict fanout and fanin trees according to an embodiment of the present invention;

FIGS. 8-9 depicts a replication tree process according to an embodiment of the present invention;

FIG. 10 depicts c-slowest paths tree according to an embodiment of the present invention;

FIG. 11 depicts a gain graph in a legalizer according to an embodiment of the present invention;

FIG. 12 depicts a flowchart of a method operating in a CAD (Computer Aided Design) system according to an embodiment of the present invention;

FIGS. 13-15 depict a process for cell unification according to an embodiment of the present invention;

FIG. 16 depicts replication statistics for a circuit ex 1010 according to an embodiment of the present invention; and

FIG. 17 depicts a table comparing timing-driven Versatile Place and Route (VPR), local replication normalized to VPR, and replication tree embedding normalized to VPR according to an embodiment of the present invention.

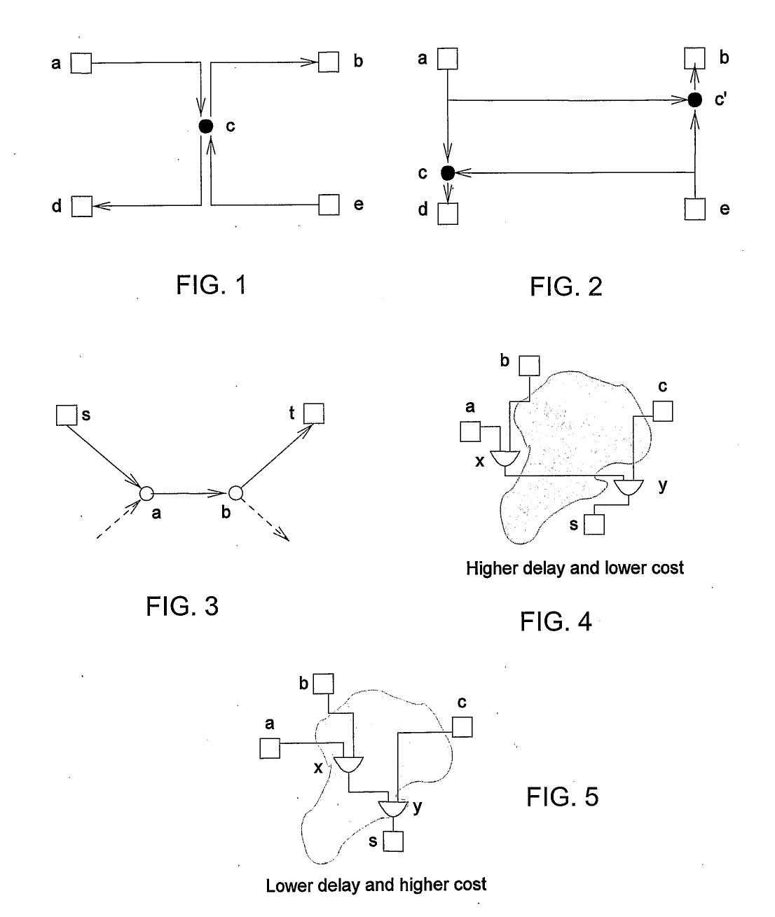

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

Fanin trees have been referred to as Fan-Out-Free Circuits or Leaf-DAG (Directed Acyclic Graph) Circuits (see S. Devadas, A. Ghosh, K. Keutzer, “Logic Synthesis,” McGraw-Hill, 1994; incorporated herein by reference and referred to hereafter as “Reference [8]”). Either of these embodiments of fanin trees is applicable to the present invention. The root of a fanin tree (e.g., a flip-flop or FF) is given with a tree circuit, which produces its inputs and arrival times at the inputs (leaves) of the fanin tree. The goal of fanin tree embedding is to embed the tree so as to obtain a tradeoff between the cost of the embedding (which can be quite general as will be seen) and the arrival time at the root (sink) of the fanin tree. The present invention relates in part to the problem of embedding a fanout tree in buffer tree synthesis (see M. Hrlic, J. Lillis, “S-Tree: A Technique for Buffered Routing Tree Synthesis,” DAC, 2002; incorporated herein by reference and referred to herein as “Reference [9]”).

While this is an interesting result in its own right, unfortunately, most circuits, because of reconvergence, do not contain large sub-circuits, which are fanin trees. The replication tree gives a systematic way of taking a set of edges in a circuit forming a directed tree (e.g., with the root being the input of a flip-flop), and, using replication, to induce a genuine fanin tree which can, in turn, be optimized by a fanin tree embedder. For timing optimization, a natural selection for such a tree is a slowest paths tree derived from static timing analysis. At this point, the embedder's ability to handle general cost functions becomes important. In particular, the cost/benefit of replicating a cell can be encoded in the “placement cost” component of the cost function.

Around these ideas—fanin tree embedding and the replication tree—an optimization engine can be developed for FPGA (Field Programmable Gate Array) designs as well as other conventional integrated circuit (IC) designs in accordance with an embodiment of the present invention.

Fanin Tree Embedding

In the Fanin tree embedding problem a fanin tree is given with placement of leaves (inputs) and root (sink), arrival times at the inputs and a target placement region (in the present case this is encoded in an embedding graph). The goal is to place the internal tree nodes (gates) minimizing cost subject to an arrival time constraint at the root (typically, there is a tradeoff between cost and arrival time).

In the general case, the cost function is extremely flexible and may include, in addition to wire-length cost, “placement cost” in which a cost Pᵢⱼ is incurred when cell i is placed at slot j. This is useful since it allows a cost “discount” if a cell is placed “on-top” of a logically equivalent cell (and thus these two cells can be unified). Thus, the solutions to the embedding problem naturally capture replication overhead. Although a simple linear program can solve special cases of the embedding problem, it is observed to be incapable of solving it in the generality of the present invention (see M. Jackson, E. Kuh, “Performance-driven Placement of Cell Based IC's,” DAC, 1989; incorporated herein by reference and referred to herein as “Reference [10]”).

FIGS. 4 and 5 illustrate two embeddings of the same fanin tree according to an embodiment of the present invention. The shaded region in the middle represents a high placement cost. Accordingly, a solution can be developed with a smaller cost but larger delay (see FIG. 4), or a solution with better delay but larger cost (see FIG. 5).

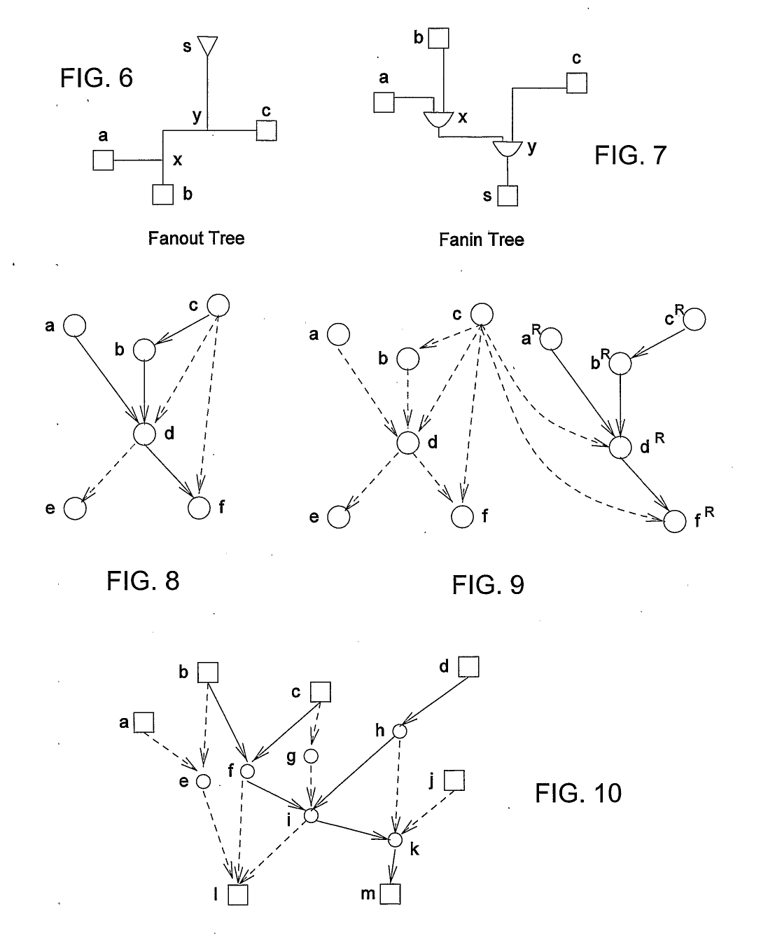

It has been observed that the problems of embedding fanin and fanout trees are very similar (see Reference [9]; and M. Hrkic, J. Lillis, “Buffer Tree Synthesis With Consideration of Temporal Locality, Sink Polarity Requirements, Solution Cost, Congestion and Blockages,” IEEE Transactions on CAD, 2003; incorporated herein by reference and referred to herein as “Reference [11]”). FIGS. 6 and 7 provide illustrations according to an embodiment of the present invention. In FIG. 6 a fanout tree has a source s and sinks a, b and c (signal flow is from top to bottom). In fanout tree embedding Steiner nodes x and y are placed. For an understanding of Steiner nodes see, “The Steiner Tree Problem”, by Frank Hwang, Dana Richards, and Pawel Winter, incorporated herein by reference. In the fanin tree case, of FIG. 7, sink s is provided along with inputs a, b and c, and gates x and y. The Dynamic Programming (DP) embedding algorithm of the S-tree algorithm of Reference [9] can be adapted to the fanin tree problem.

The DP approach for fanout tree embedding starts from sinks and propagates required-arrival time and cost toward the source. In the case of a fanin tree the algorithm begins from inputs and propagate arrival time, and cost toward the sink. In the resulting DP approach for fanin tree embedding, a candidate solution (embedding) for a sub-tree rooted at node i in the tree with node i placed at vertex j in the embedding graph is represented by its signature (c, t), indicating that this subsolution incurs cost c and has latest arrival time t at i. Solutions at leaves are initialized to have zero cost and arrival times as specified by the problem instance (which is zero for primary inputs and FFs and latest arrival time computed by static timing analysis for other leaves).

In the bottom-up DP procedure candidate solutions are combined from sub-trees to form new candidate solutions. At internal node i in the tree and vertex j in the graph, sub-tree solutions can be joined as follows:
c=pᵢⱼ+c₁+c₂+ . . . +cₖ
t=max(t₁, t₂, . . . , tₖ)

where k is the number of inputs for gate at i, and p_{i,j} is placement cost. For each pair (i,j) instead of a single best solution a list is kept of non-dominated solutions. One solution dominates the other if it is superior in both dimensions (i.e., both cheaper and faster). After computing joined solutions, they are propagated through the embedding graph using generalized version of Dijkstra's shortest path algorithm, as described in Reference [9]. At the root a set of solutions is obtained with cost versus delay trade-off. From the trade-off curve a fastest solution is selected that is not faster than the precomputed lower-bound on a best possible circuit worst delay (which is in general limited by distance between primary inputs, PIs, and primary outputs, POs, and a number of logic blocks in between).

It will be appreciated by one of ordinary skill in the art that the foregoing embedding algorithm can embed a fanin tree into any graph-based target. Accordingly, it can be used for FPGAs and related technologies in which physical distance between points is not a good guide for delay estimation because of the underlying routing architecture.

The Replication Tree

Since most circuits do not have large fanin trees due to reconvergence, a replication tree can be applied to induce large fanin trees in a logically equivalent circuit. It will be appreciated by one of ordinary skill in the art that any other approach for inducing fanin trees from a layout can be applied to the present invention. The approach of utilizing replication trees to induce fanin trees is illustrated by way of example in FIGS. 8 and 9 according to an embodiment of the present invention.

In FIG. 8 a portion of a circuit is provided with a tree having all edges pointing toward a root (f). Note that this tree does not form a valid fanin tree due to reconvergence. To induce a fanin tree (temporarily) a copy is made of each node in the tree (f,d,a,b,c). If the original cell is ν and a copy is ν^{R}, connections are assigned as follows. If the root is among ν's outputs, then ν^{R}'s output connects to the root and only the root. The original cell ν drives the other fanouts (if any). If an internal node w is among ν's outputs, then ν^{R}'s output connects to w^{R} and only w^{R}. Again, the original cell w drives the other fanouts (if any). From this a general derivation can be developed. That is, let u₁, . . . , uₖ be the inputs to ν. If (uᵢ, ν) is a tree edge, then ν^{R} receives its i'th input from uᵢ^{R}; otherwise, it receives its i'th input from uᵢ (note that uᵢ may indeed be replicated).

This construction is applied to the circuit in FIG. 8 and results in the circuit of FIG. 9 yielding a fanin tree sub-circuit formed by the replicated cells. Notice that cells d^{R} and f^{R} connect to c rather than c^{R}—otherwise, the replicated cells would not form a proper fanin tree. Technically speaking this is a Leaf-DAG because, for example, “leaf” node c connects to two cells in the tree. However, since the timing properties of c are fixed and known, this does not complicate the embedding process. If the circuit is modified in this way (again, temporarily), the result is functionally equivalent, which is clear from the construction. Additionally, the set of replicated nodes form the internal vertices of a legitimate fanin tree, which can be embedded.

The temporary nature of the replication can now be associated with the placement cost, which can be incorporated into the embedding formulation. As noted earlier placing a node coincidentally with a logically equivalent node receives a “discount.” In the context of the replication, this should now become clear—if the embedder places ν^{R} at the same location as ν, there is no replication and thus, implicitly replication is applied only to the cells that yield the most significant improvement. A special case may occur if node ν has fanout of one. In this case, replication still takes place but all placement locations receive a discounted cost, since no actual replication will ever occur.

Over the course of multiple optimizations, there may be more than two copies of a cell. Placement cost is therefore assigned accordingly in such situations (i.e., placement with any logically equivalent cell receives a discounted cost, not only with the immediate source of the replication).

Clearly there are many trees in a timing graph, which can be used to generate a replication tree. For timing optimization, it is natural to focus on trees with slow paths. The slowest paths tree (SPT) can be thought of as the result of finding a longest paths tree from the critical sink in the timing graph with the edges reversed (equivalently, finding the shortest paths tree in the reversed graph with the delay values negated). Finding this tree is trivial once the static timing analysis has completed.

Similarly, an ε-SPT is a subset of the slowest paths tree which includes only cells with paths within ε of the current critical path delay. This allows for focus on the most critical portions of the fanin cone of the critical sink. An example of ε-slowest slowest paths tree is given in FIG. 10 according to an embodiment of the present invention. Circuit inputs are a, b, c, d and j. Outputs are l and m. Sink m has been identified as critical. Edges of the ε-SPT are shown with solid lines and dashed edges representing circuit connectivity. Note that g and j are not contained in the ε-SPT.

Timing-Driven Legalization.

After the foregoing steps, it is possible that some cells overlap in the placement. The purpose of the legalization process is to resolve those overlaps and move cells from congested to empty locations. It is observed that by moving cells that are on the critical path one may degrade circuit performance. In order to minimize perturbations to the placement and preserve timing achieved in the embedding phase (as much as possible), a ripple-move strategy is adopted as described in S. W. Hur, J. Lillis, “Mongrel: Hybrid Techniques for Standard Cell Placement,” ICCAD, 2000, incorporated herein by reference and referred to herein as “Reference [12]”. According to the present invention, this strategy has been modified to incorporate timing as well as wiring information.

The legalizer is invoked after each embedding phase. During embedding it is possible that replication and/or movement of multiple cells take place, so there may be more than one violation in the placement. If an overlap-free placement is achievable (i.e. there are enough free slots), the legalizer will resolve one overlap at a time until the entire placement is legal.

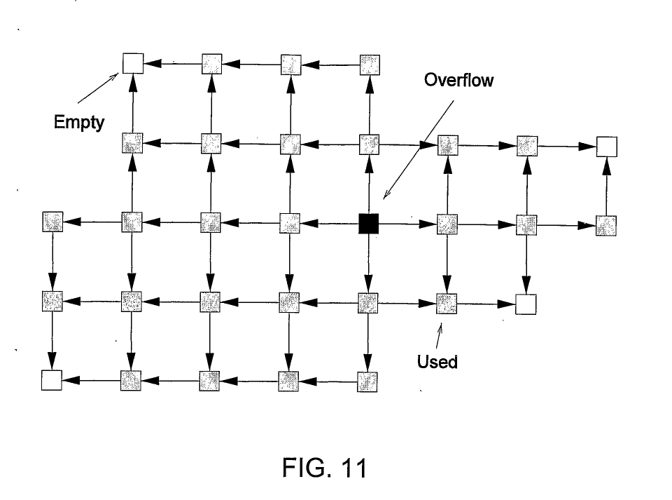

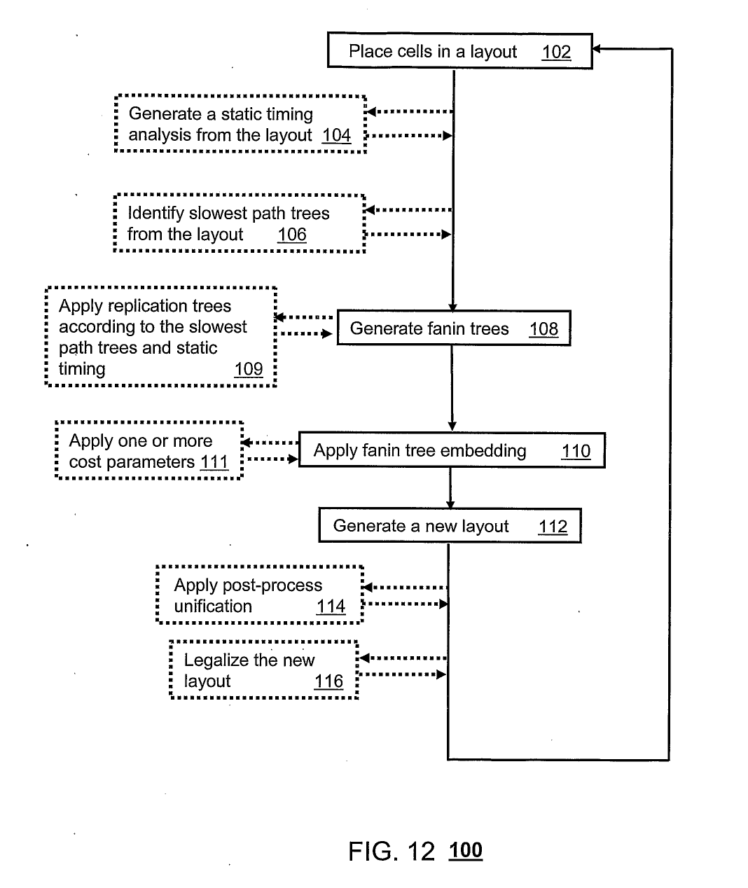

In the procedure an overlap location is first identified. If there is more than one overlap, the first one encountered is selected while placement is scanned for overlaps. Up to four closest free slots are identified (one slot in each quadrant, if they exist, assuming that the center is at the congested slot). Next identification is made as to which of those free slots will be used for legalization. To do this, a gain graph is constructed as shown in FIG. 11, which has monotone paths from a congested slot to free slots. Each edge can be labeled by the gain value attained by moving a cell from one slot to a neighboring slot (in a direction toward the target free slot).

Gain can be computed as the difference of the cost of having a cell at the neighboring slot and the cost at current slot. This cost can have a wire and a timing component. Wire cost is the sum of the estimated wire lengths of the net for which current cell is a root and those nets for which current cell is a sink. As a wire length estimation a half-perimeter metric augmented by a net size coefficient is used as described in A. Marquardt, V. Betz, J. Rose, “Timing-Driven Placement for FPGAs,” International Symposium on FPGAs, 2000, incorporated herein by reference and referred to herein as “Reference [13]”.

Timing cost can be computed as the squared delay of the slowest path through the current cell if such delay approaches the critical delay (above 60% in present experiments) and zero otherwise. In this way, moves that are likely to make a near critical path worse are discouraged. The cost of a cell at particular location is a composite of timing and wire cost:
C=αC_{T}+(1−α)Cw.

Gain of moving cell from current to new location is:
Gain=C_{new}−C_{curr}.

Once the gain graph has been constructed, a determination is made of the max-gain path in the graph using a target slot with the highest gain for ripple-move legalization. Note that to minimize perturbations of the placement cells are moved at most one slot during a ripple move. Another motivation for this is that the embedder has a much stronger algorithm for optimizing cell locations, so it is helpful to keep cells as close to those locations as possible. Note that the best gain value could still be negative (i.e., there may be a loss of some quality/performance). During ripple-moves it is possible that a cell may be moved to a slot that contains one of its logically equivalent cells. In that case, the cells are unified halting the current pass of a single overlap legalization.

Method of Operation.

FIG. 12 depicts a flowchart of a method 100 operating in a CAD (Computer Aided Design) system according to an embodiment of the present invention. Method 100 begins with step 102 where a number of cells of a circuit are placed in a layout. This step can be implemented as in Reference [5] from a valid timing-driven placement produced by a Versatile Place and Route (VPR) as described in Reference [13]. In step 108, fanin trees are generated. In a first embodiment of the present invention, replication trees can be applied in step 109 to generate the fanin trees. To assist the replication process, a static timing analysis along with a slowest path trees analysis can be applied in steps 104 and 106.

As discussed previously, the ε-SPT can be used to guide replication tree construction. The value of ε is initially set to zero and is dynamically updated in the main loop of optimization flow. Since the approach has no randomized components, when no improvement is found for a tree rooted at a particular critical sink, no further improvement can be made in subsequent iterations since the same sink will still be critical and the same tree will be selected. This problem is addressed by dynamically increasing the value of c when non-improvement occurs. As a result the extracted tree enlarges the solution space giving more freedom in tree embedding optimization.

It should be evident to one of ordinary skill in the art that any method for generating fanin trees can be applied to the present invention. In this context any present and/or future methods for fanin tree generation are considered to be within the scope and spirit of the claims described herein.

In step 110, fanin tree embedding is applied to the fanin trees generated in step 108. As a supplemental embodiment, in step 111 a family of solutions is produced that trades off cost parameters. Any number of cost parameters can be considered such as, for instance, cost due to propagation arrival times, placement costs, wire-length costs, die size cost, and/or power consumption costs, just to mention a few. It will be appreciated by an artisan with skill in the art that any cost function suitable to the present invention can be applied to the fanin tree embedding step 110.

From the results of step 110 a new layout is created in step 112. In a supplemental embodiment, a post-process unification step 114 can be applied. To improve timing, some cells can be placed close to logically equivalent cells but not quite on top of them. In this case implicit cell unification will not occur. However, it is possible that some of the equivalent cells lie on non-critical paths and that their child cells can pick up a signal from the newly replicated cell without degrading their arrival time (sometimes delay can even improve).

As a post-process step, for each newly replicated cell all logically equivalent cells are examined. If any fanout cell of those equivalent cells can improve its arrival time by taking the corresponding input from a newly replicated cell, it is reassigned to the new replica. In this way delay can be improved on paths that were not explicitly captured by the replication tree. It is possible that in this process some of the equivalent cells remain without fanout (i.e., no cell is using their output). In this case such cells are deleted as redundant. Once a cell is deleted, child count of its parents are reexamined since a deleted cell could have been the only child of its parent cell and then the parent itself becomes redundant. This test is applied recursively up the path.

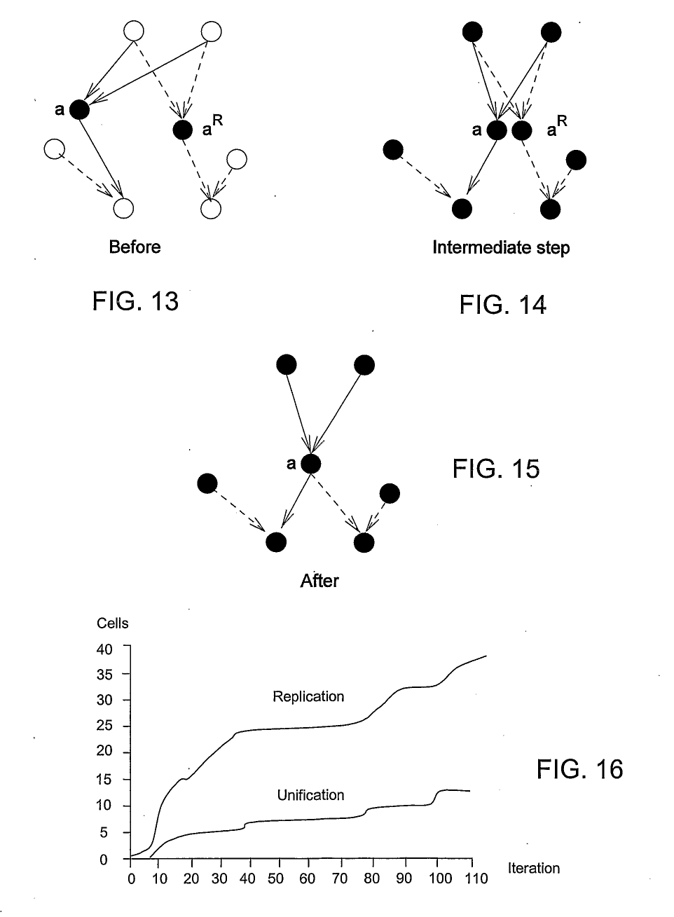

An example of this scenario in practice occurs with a non-tree structure (DAG—Directed Acyclic Graph) on one side of the FPGA. In each iteration a part of the DAG is extracted as a replication/fanin tree, optimized and placed further away so that replication must occur. In consecutive iterations the other parts of the DAG slowly migrates to the other side. Finally, the entire DAG can migrate to the other side, in which case replications, although necessary for an intermediate solution, are now completely redundant. Unification naturally handles this anomaly. FIGS. 13-15 show an example of unification according to the foregoing descriptions as an embodiment of the present invention. Before optimization there is cell α and its replica α^{R} (see FIG. 13). Cell α gets relocated to a proximity of cell α^{R} (see FIG. 14). Timing analysis reveals that children of α^{R} can get a signal from α without degrading worst delay through it so unification is performed as shown in FIG. 15.

FIG. 16 shows the relation between replicated and unified cells for a sample circuit ex 1010 in accordance with an embodiment of the present invention. The optimization took 106 loop iterations and during that time 38 cells were replicated but 12 were unified giving a total of 26 replications at the end.

In yet another supplemental embodiment, the new layout is legalized in step 116 according to the timing-driven legalization processed described earlier. After legalization has completed, the results are fed back to the VPR's detailed router in step 102 to accurately assess the results. Thus, method 100 is not intended to replace any existing optimization steps in step 102, but rather to complement it. The core replication procedure discussed above is focused on highly timing-critical sub-circuits and thus, while the embedding algorithm is nontrivial, the runtime penalty for using such a sophisticated algorithm is very small in the scope of the entire flow (as has been verified experimentally).

In an experimental setup applied to the present invention essentially the same placement-level delay estimator as used by VPR of References [5] and [13] was used. For the target FPGA architecture under consideration, all the switches were buffered and interconnect resources were uniform. As a result, RC (Resistance-Capacitance) effect was localized and thus the interconnect delay was reasonably approximated by a linear function of the Manhattan length of the interconnect. As an aside, it is noted that in principle, the embedding algorithm discussed above can use more general delay models.

Experiments.

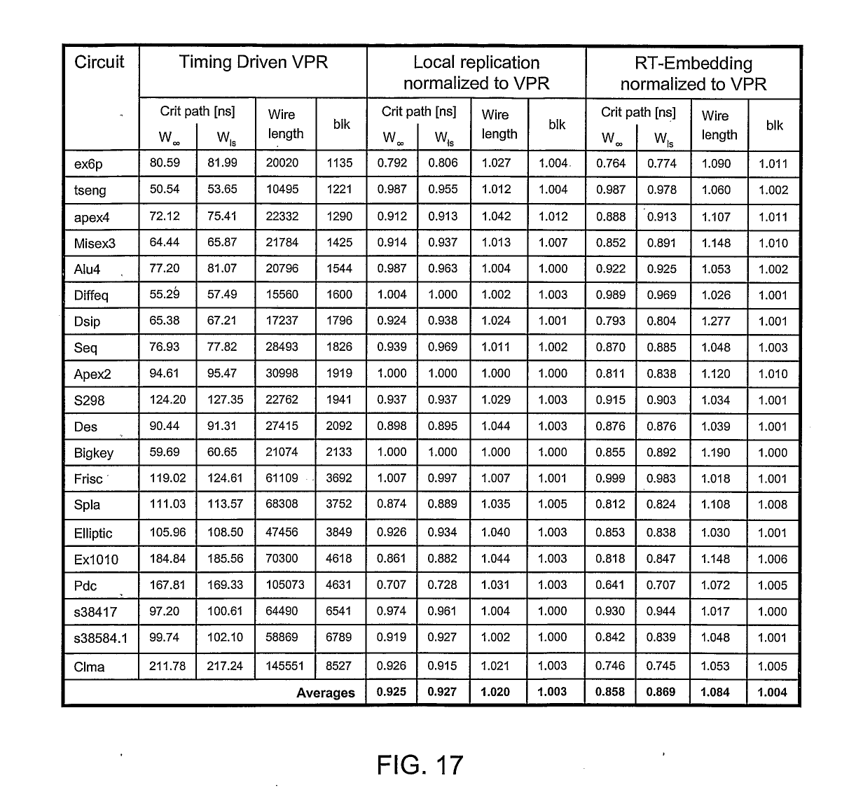

Method 100 as embodied in FIG. 12 (herein referred to also as the Replication Tree Embedding algorithm) has been implemented experimentally to evaluate its effectiveness. The experiments were conducted in a LINUX environment on a PC with an Intel Pentium 1.3 GHz CPU and 256 MB of RAM (Random Access Memory). The main criteria of interest were the maximum delay through the circuit (i.e., clock period), wire length and number of logic blocks. All such statistics were reported by a VPR timing-driven router. Method 100 was compared to the Timing Driven VPR of Reference [13] and with the local replication algorithm from Reference [5]. FIG. 17 shows the experimental results for 20 MCNC (Microelectronics Center of North Carolina) benchmark circuits.

As noted in method 100, a timing driven VPR was used to place the circuits in step 102. In the first data set no additional optimizations were performed. In the second data set placement was optimized by local replication algorithm, and in the third data set placement was optimized using Replication Tree (RT) Embedding. All placements were routed using VPR in a timing driven mode. Since the local replication algorithm is randomized, it was executed three times while recording best results. The circuits were placed on the minimum square FPGA able to contain the circuit. As in Reference [13] low-stress routing was defined as routing where FPGA has about 20% more routing resources available than the minimum required to successfully route the circuit. Also from Reference [13], infinite-resource routing occurs when the FPGA has unbounded routing resources. It is argued in Reference [13] that the former represents the situation how FPGAs would be routed in practice and the latter is a good placement evaluation metric. For post-place-and-route experiments both low-stress (Wₗₛ) and infinite-resource (W_{∞}) critical path delay numbers are presented. Results for local replication and RT Embedding are normalized to VPR results.

The results of FIG. 17 show that the present invention improves critical path delay over VPR for all circuits in the test suite. The best delay reduction of 36% was achieved for circuit pdc. Average delay reduction was 14.2%, which almost doubles the average delay improvement of the local replication algorithm. The largest improvement over local replication is almost 19% for circuit apex2, for which local replication was not able to improve critical path delay at all. It was observed that wire-length degradation based results from the present invention was 8.4% on average, and average number of newly introduced cells by replication was only 0.4% of the total number of cells. One may argue that the increase in wire length is not negligible. However, perhaps more important than wire length is routability, which in the present experiments all designs were always successfully routed (this is most relevant in the case of Wₗₛ).

Runtime overhead when applying the present invention was very modest—under 5% of the time of the VPR flow (place and route). Note that low-stress routing critical path delay is slightly worse that the case with infinite routing resources. Degradation is consistent for all circuits in the test suites and also correlates with low-stress routing behavior conclusions from Reference [13].

A general and robust approach to timing-driven, placement-coupled replication has been presented in accordance with the present invention. An efficient algorithm for optimal fanin tree embedding was introduced under a general cost model. A replication tree process was used for inducing large sub-circuits, which can be optimized by fanin tree embedding. The approach has a number of interesting properties including implicit unification of logically equivalent cells. Around the ideas presented by method 100 an optimization engine has been developed for the FPGA (and other suitable IC) domains demonstrating very promising results. The aforementioned techniques provide useful bridges between placement, routing and logic (re-)synthesis.

It should be evident from the foregoing discussions that the present invention can be realized in hardware, software, or a combination thereof. Additionally, the present invention can be embedded in a computer program of a CAD system, which comprises all the features enabling the implementation of the methods described herein, and which enables said devices to carry out these methods. A computer program in the present context means any expression, in any language, code or notation, of a set of instructions intended to cause a system having an information processing capability to perform a particular function either directly or after either or both of the following: a) conversion to another language, code or notation; b) reproduction in a different material form. Additionally, a computer program can be implemented in hardware as a state machine without conventional machine code as is typically used by CISC (Complex Instruction Set Computers) and RISC (Reduced Instruction Set Computers) processors.

It should also be evident that the present invention may be used for many applications. Thus, although the description is made for particular arrangements and methods, the intent and concept of the invention is suitable and applicable to other arrangements and applications not described herein. For example, method 100 can be reduced to steps 102, 106, 110 and 112 without departing from the claimed invention. It would be clear therefore to those skilled in the art that modifications to the disclosed embodiments described herein can be effected without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description are to be construed to be inclusive of the scope of the invention as defined in the following claims. Thus, reference should be made to the following claims, rather than to the foregoing specification, as indicating the scope of the invention.

What is claimed is:

1. In a Computer-Aided Design (CAD) system a computer-readable storage medium, the storage medium comprising computer instructions for:
placing a plurality of cells of one or more circuits in a layout;
generating a plurality of fanin trees from the layout;
applying fanin tree embedding on the plurality of fanin trees; and
generating a new layout from the embedded fanin trees.

2. The storage medium of claim 1, comprising computer instructions for:
generating a static timing analysis from the layout; and
generating the plurality of fanin trees according to the static timing analysis.

3. The storage medium of claim 1, comprising computer instructions for generating the plurality of fanin trees from replication trees.

4. The storage medium of claim 1, comprising computer instructions for applying fanin tree embedding according to one or more cost parameters.

5. The storage medium of claim 4, wherein the one or more cost parameters are defined by at least one of a group of cost parameters comprising propagation arrival time cost, placement cost, wire-length cost, die size cost, and power consumption cost.

6. The storage medium of claim 3, comprising computer instructions for:
identifying slowest path trees from the layout;
generating the replication trees according to the slowest path trees.

7. The storage medium of claim 3, comprising computer instructions for generating the replication trees according to arrival times of signals feeding the plurality of cells.

8. The storage medium of claim 1, comprising computer instructions for applying a post-process unification on the new layout.

9. The storage medium of claim 1, comprising computer instructions for legalizing the new layout.

10. The storage medium of claim 1, comprising computer instructions for routing of the new layout.

11. In a Computer-Aided Design (CAD) system, a method comprising the steps of:
placing a plurality of cells of one or more circuits in a layout;
generating a plurality of fanin trees from the layout;
applying fanin tree embedding on the plurality of fanin trees; and
generating a new layout from the embedded fanin trees.

12. The method of claim 11, comprising the steps of:
generating a static timing analysis from the layout; and
generating the plurality of fanin trees according to the static timing analysis.

13. The method of claim 11, comprising the step of generating the plurality of fanin trees from replication trees.

14. The method of claim 11, comprising the step of applying fanin tree embedding according to one or more cost parameters.

15. The method of claim 14, wherein the one or more cost parameters are defined by at least one of a group of cost parameters comprising propagation arrival time cost, placement cost, wire-length cost, die size cost, and power consumption cost.

16. The method of claim 13, comprising the steps of:
identifying slowest path trees from the layout;
generating the replication trees according to the slowest path trees.

17. The method of claim 13, comprising the step of generating the replication trees according to arrival times of signals feeding the plurality of cells.

18. The method of claim 11, comprising the step of applying a post-process unification on the new layout.

19. The method of claim 11, comprising the step of legalizing the new layout.

20. In a Computer-Aided Design (CAD) system a computer-readable storage medium, the storage medium comprising computer instructions for:
placing a plurality of cells of one or more circuits in a layout;
generating a static timing analysis from the layout;
generating a plurality of fanin trees from replication trees according to the layout and the static timing analysis;
applying fanin tree embedding on the plurality of fanin trees; and
generating a new layout from the embedded fanin trees.
